(19) United States
(12) Patent Application Publication
(10) Pub. No.: US 2003/0122404 A1
(43) Pub. Date: Jul. 3, 2003

(54) Dashboard structural assembly and method for the production of same

(76) Inventor: David Duchez, Conflans-Sainte-Honorine (FR)

Correspondence Address: ROTHWELL, FIGG, ERNST & MANBECK, P.C., 1425 K STREET, N.W., SUITE 800, WASHINGTON, DC, 20005, US

(21) Appl. No.: 10/326,550

(22) Filed: Dec. 23, 2002

(30) Foreign Application Priority Data
Dec. 27, 2001 (FR) 01 16948

(51) Int. Cl. B62D 25/14

(52) U.S. Cl. 296/208; 296/70

(57) ABSTRACT

Dashboard structural assembly comprising a formed elongate metal structure (2) and a structuring functional member (4) of plastics material incorporating an air duct, over-moulded on the elongate metal structure. The elongate metal structure (2) comprises a first portion having a first thickness and a second portion having a second thickness which is less than the first.

### BACKGROUND OF THE INVENTION

1. Field of the invention

The invention concerns a dashboard structural assembly and a method for producing such an assembly.

2. Description of the Prior Art

Conventionally, a motor vehicle dashboard comprises an elongate metal structure, generally tubular and termed cross-member, intended to hold the front chassis legs of the vehicle in position and act as support for functional members which will be fixed thereupon, and generally to limit deformation of the passenger compartment.

The objective of the invention is to reduce the number of parts constituting the structure of the dashboard and the number of assembly operations, in order to reduce the costs, overall dimensions and weight of such a structure.

Some dashboard structures currently on the market comprise a metal cross-member composed of two tubular portions of different cross-sections, welded end-to-end, in order to adapt the strength of the cross-member to the stresses to be absorbed. In fact, in the event of an accident, the dashboard structure should, among other things, limit the intrusion into the passenger compartment of the steering column and its components close to the driver (steering wheel, air bag, technical sheath, etc.); however, these are present only on the driver's side. By providing a portion of metal cross-member of lower strength on the passenger's side than on the driver's side, the weight of the dashboard is reduced, without downgrading its specification. However, such a dashboard with a metal mechanical/welded cross-member composed of two tubular portions of different cross-sections does indeed have a reduced weight compared with conventional dashboards, but does not make it possible to obtain all the advantages envisaged by the invention.

It is moreover proposed, in particular in U.S. Pat. No. 5,358,300, to omit the elongate metal structure and to produce a dashboard of plastics material which has been adapted, in particular by the assembly of a plurality of heavily ribbed layers, to take up the stresses absorbed conventionally by the elongate metal structure. In addition, some functional members such as the air ducts are incorporated and not added on to the dashboard structure. However, such a solution does indeed make it possible to reduce the weight of the dashboard, simplify its assembly and improve its compactness, but it is complex to define, develop and implement without, nevertheless, obtaining the same mechanical strength as a dashboard equipped with an elongate metal structure.

### SUMMARY OF THE INVENTION

In order to remedy these various drawbacks, the invention proposes that the dashboard structural assembly comprises:

an elongate metal structure comprising a first portion having a first thickness and a second portion having a second thickness which is less than the first, and

a structuring functional member of plastics material incorporating an air duct, over-moulded on the elongate metal structure.

The elongate metal structure provides the essential part of the mechanical strength. Its strength is adapted according to the different levels of stress to which it is subjected over its length by the presence of two portions of different thicknesses. Since the functional member is over-moulded on the elongate structure, it forms a one-piece assembly therewith, such that in addition to incorporating a ventilation function, it further withstands part of the mechanical stresses, thereby making it possible to reduce the thickness of the elongate structure.

The weight of the dashboard is consequently reduced. In addition, the overall dimensions of the dashboard and the number of assembly operations are reduced owing to the incorporation of the ventilation and mechanical function in the over-moulded functional member.

The invention further concerns a method for producing such a dashboard structural assembly. According to the invention, the method comprises the following steps:

forming a metal plate to produce an elongate structure comprising a first portion having a first thickness and a second portion having a second thickness which is less than the first, and

over-moulding the elongate structure with plastics material to obtain a functional member of plastics material rigidly connected to the elongate metal structure.

In addition to the aforesaid advantages, this solution makes it possible, owing to the production of the elongate structure by forming, on the one hand to adapt the mechanical strength of the elongate structure relatively easily over its length according to the levels of stress to which it is subjected, and on the other hand to over-mould the elongate structure relatively easily in spite of the presence of two portions of different thicknesses.

By forming, there is to be understood a die stamping, swaging, shaping or similar operation.

According to a complementary feature, the invention proposes that a first metal plate having substantially said first thickness and a second metal plate having substantially said second thickness are die stamped, then the first and second metal plates are assembled to produce the elongate structure, before over-moulding it.

As a variant, the invention proposes that:

a first metal plate having said first thickness and a second metal plate having said second thickness are placed in a die stamping mould, providing a junction zone in which the first and second metal plates overlap each other,

then the first and second metal plates are die stamped and assembled simultaneously by deformation in the junction zone of the first and second metal plates.

Thus, the production of the elongate structure having two different thicknesses is carried out in a single operation. Assembly may be effected especially by punching, clinching or adhesively securing.

According to another variant, the invention proposes rolling a metal sheet of substantially constant thickness in a rolling mill in order to obtain said metal plate having in a first zone substantially said first thickness and in a second zone substantially said second thickness.

This solution makes it possible to obtain very simply the elongate structure with its different thicknesses. In order so to do, the cylinders of the rolling mills may comprise a non-circular cross-section composed of a plurality of (at least 2) circular arcs of different radii.

The invention will become clearer from the following description, provided with reference to the appended drawings.

### BRIEF DESCRIPTION OF THE DRAWINGS

FIG. 1 illustrates in perspective a first step of a method according to the invention,

FIG. 2 is a perspective view in the plane II-II in FIG. 1,

FIG. 3 is a perspective view of a second step of the method,

FIG. 4 is a perspective view of a dashboard structural assembly according to the invention, obtained during a third step of the method,

FIG. 5 illustrates diagrammatically a step of the method according to the invention for obtaining the elongate metal structure.

### DETAILED DESCRIPTION OF THE PREFERRED EMBODIMENTS

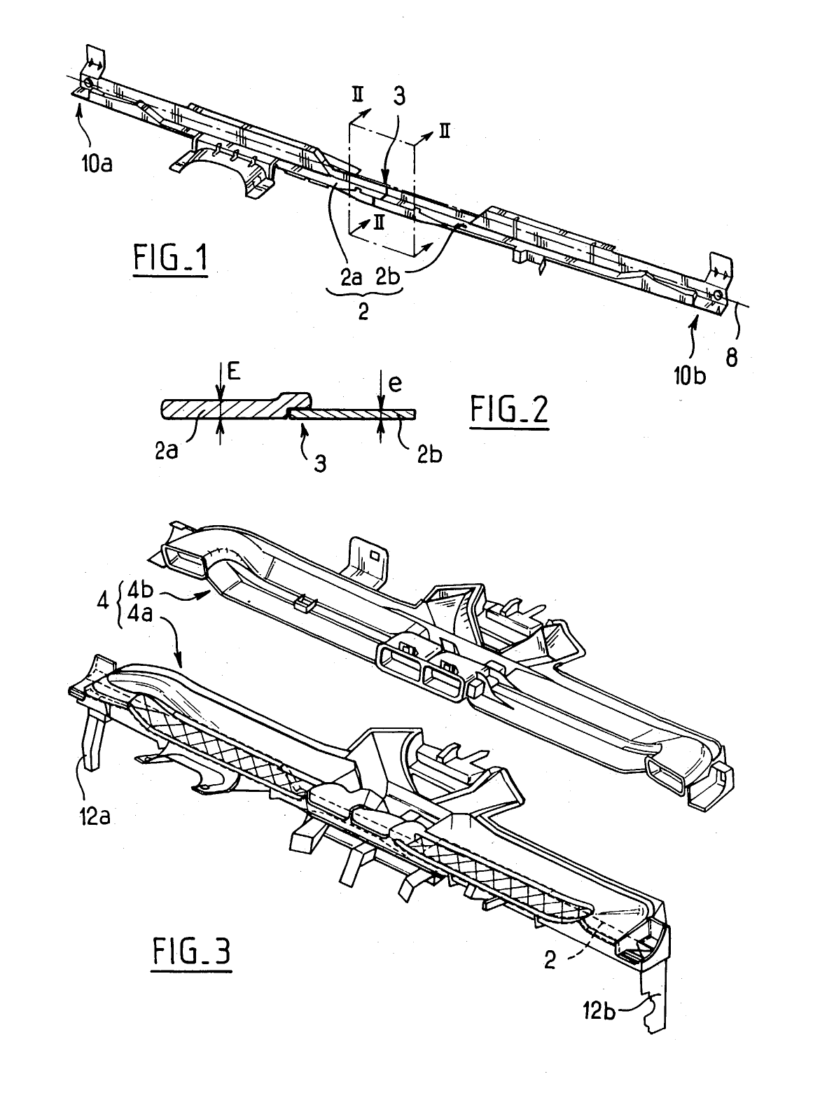

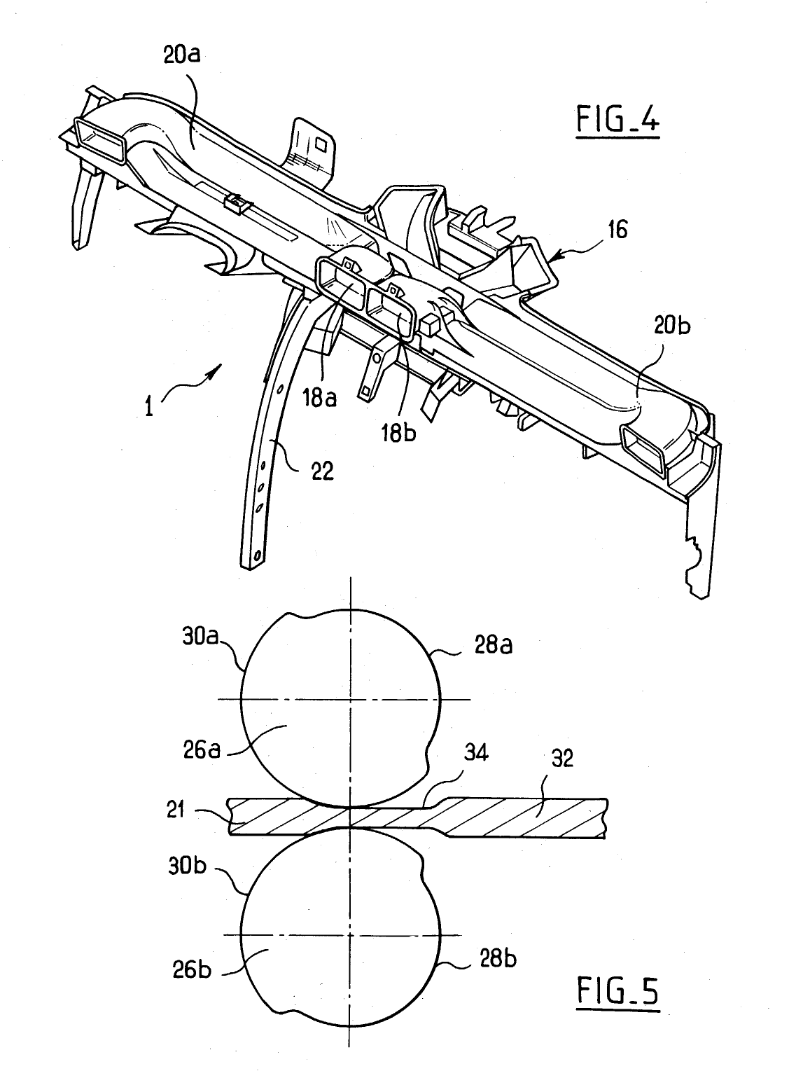

FIG. 1 illustrates an elongate metal vehicle structure 2 having a substantially U-shaped cross-section and comprising two portions. One portion, 2a, particularly robust, located on the left in the figure, is intended to face the driving seat. It represents substantially 40% of the total length of the elongate structure.

The other, lighter, portion 2b, located on the right in the figure, is intended to face the major part of the central console of the vehicle and the passenger. It represents substantially 60% of the total length of the elongate structure.

These two portions 2a, 2b have been obtained by forming, especially by die stamping, metal plates of different thicknesses, such that the robust portion 2a has a thickness E substantially twice that of the light portion 2b. Preferably, the robust portion will have a thickness substantially between 1 and 3 millimetres, while the light portion 2b will have a thickness substantially between 0.3 and 2.5 millimetres.

The two portions 2a, 2b of the elongate structure may be assembled in prolongation of each other, after forming, by welding, in particular by spot welding, or by adhesively securing, with a slight overlap.

As a variant, the assembly of the two portions 2a, 2b of the elongate structure may be effected by punching or clinching, at the same time as the die stamping of the plates from which they are obtained, after having superposed them in a junction zone 3.

The assembled elongate structure then extends in a direction of elongation 8, between two ends 10a, 10b.

The elongate structure 2 is then introduced into a mould, where it is covered with plastics material by injection moulding. The workpiece 4a of plastics material obtained envelopes the elongate structure 2 and incorporates pillars 12a, 12b located at the ends 10a, 10b, intended to be fixed to the front chassis legs of the vehicle, but above all a ventilation assembly comprising air outlets 16 for de-icing, central ducts 18a, 18b and lateral ducts 20a, 20b.

Said workpiece 4a constitutes the body of a structural member 4 and defines the lower portion of said functional member 4, which further comprises an upper portion 4b, forming a cover which covers said body 4a.

The functional member 4 of plastics material and the elongate metal structure 2 constitute a dashboard structural assembly 1 intended to provide the connection between the front chassis legs of the vehicle via the pillars 12a, 12b and to serve as stress absorber for an air bag module and as support for a steering column and the dashboard.

In proximity to the junction zone 3, a strut 22 is fixed to the robust portion 2a of the elongate structure, to take up part of the stresses withstood by the elongate structure and to transmit them to the structure of the vehicle via the floor. Alternatively, the strut 22 could make it possible to support the floor of the vehicle by means of the structural assembly.

FIG. 5 illustrates a variant for producing the elongate structure 2, consisting in passing a metal sheet 24 of substantially constant thickness between two rolling mill rolls 26a, 26b, each having two circular portions 28a, 28b; 30a, 30b of different radii. Thus, in the course of rotation of the rolls, the gap between the rolls is successively around E, then e, such that a plate is obtained having in a first portion 32 the thickness E corresponding to the robust portion 2a of the elongate structure, and in a second portion 34 the thickness e corresponding to the light portion 2b of the elongate structure. By then placing said plate in a die stamping mould, the two portions 2a, 2b of the elongate structure are then obtained directly, necessarily rigidly connected to each other since they are obtained in one piece.

The invention is of course in no way limited to the embodiment which has just been described by way of non-limiting example. Thus, in order to produce the structure 2, provision could be made to carry out rolling between two rolling mill rolls, each including two portions of different diameters side by side, such that said rolls provide between them a gap substantially equal to e over one part of their length and to E over another part of their length.

Said structure could also be produced in the form of a profile section having two different cross-sections over its length.

We claim:

1. A dashboard structural assembly comprising:
an elongate metal structure comprising a first portion having a first thickness and a second portion having a second thickness which is less than the first, and
a structuring functional member of plastics material incorporating an air duct, over-moulded on the elongate metal structure.

2. A method for producing a dashboard structural assembly comprising the following steps:
forming a metal plate to produce an elongate structure comprising a first portion having a first thickness and a second portion having a second thickness which is less than the first, and
over-moulding the elongate structure with plastics material to obtain a functional member of plastics material rigidly connected to the elongate metal structure.

3. A method according to claim 2, wherein a first metal plate having substantially said first thickness and a second metal plate having substantially said second thickness are formed, then the first and second metal plates are assembled to produce the elongate structure, before over-moulding it.

4. A method according to claim 2, wherein:
a first metal plate having said first thickness and a second metal plate having said second thickness are placed in a die stamping mould, providing a junction zone in which the first and second metal plates overlap each other,
then the first and second metal plates are die stamped and assembled simultaneously by deformation in the junction zone of the first and second metal plates.

5. A method according to claim 2, wherein a metal sheet of substantially constant thickness is rolled in a rolling mill to obtain said metal plate having in one zone substantially said first thickness and in another zone said second thickness.

6. A method according to claim 2, wherein a first metal plate having substantially said first thickness, and a second metal plate having substantially said second thickness are formed, then the first and second metal plates are assembled by adhesively securing.

7. A method according to claim 2, wherein a first metal plate having substantially said first thickness, and a second metal plate having substantially said second thickness are formed, then the first and second metal plates are assembled by welding.
